(19) United States
(12) Patent Application Publication
(10) Pub. No.: US 2025/0210017 A1
(43) Pub. Date: Jun. 26, 2025

(54) AUTOMATIC GENERATION AND MULTIPLICATION OF AUDIO STEMS USING INCREMENTAL LEARNING

(71) Applicant: Endel Sound GmbH, Berlin (DE)

(72) Inventors: Oleg Stavitskii, Berlin (DE); Vladimir Terekhov, Berlin (DE); Dmitry Evgrafov, Moscow (RU); Philipp Petrenko, Berlin (DE); Dmitry Bezugly, Kaliningrad (RU); Evgeny Gurzhiy, Berlin (DE); Igor Skovorodkin, Berlin (DE); Andey Kudryavtsev, Berlin (DE); Kyrylo Bulatsev, Frankfurt (DE)

(73) Assignee: Endel Sound GmbH, Berlin (DE)

(21) Appl. No.: 18/392,800

(22) Filed: Dec. 21, 2023

(51) Int. Cl. G10H 1/00

(52) U.S. Cl. CPC G10H 1/0025; G10H 2210/111; G10H 2210/125

(57) ABSTRACT

A process can include obtaining input audio stems comprising a selected subset of a plurality of audio stems, and obtaining configuration information corresponding to audio processing operations for the input audio stems. An audio stem multiplier engine can generate a plurality of multiplied audio stems based on the input audio stems and the configuration information. Each multiplied audio stem comprises a variation of a particular input audio stem and is generated based on applying one or more audio processing operations parameterized by the configuration information. Information indicative of user feedback ratings for each respective multiplied audio stem of the plurality of multiplied audio stems can be received. The audio stem multiplier engine can generate a second plurality of multiplied audio stems based on at least the user feedback ratings and one or more of the input audio stems or the plurality of multiplied audio stems.

### FIELD

Aspects of the present disclosure generally relate to sound processing. In some implementations, examples are described for the generation and multiplication of audio stems for automatic composition.

### BACKGROUND

Technological innovation, while improving productivity, has increasingly raised stress levels in day-to-day life. The daily demands on life have become more numerous and fast-paced while the level of daily distractions has increased. New systems need to be implemented in order to address this. Individual attempts to deal with these stress-causing issues frequently involve activities such as meditation and exercise, often accompanied by music or soundscapes to augment the experience. However, these soundscapes are generally homogenous, of limited length and are not adaptive to a user's evolving environment or state, and cannot dynamically access information relevant to an individual's state and surroundings to present a personalized transmission(s) of sound for various activities, such as relaxation, focus, sleep, exercise, etc.

Music or soundscapes can additionally be used to accompany storytelling activities, which can include spoken-word storytelling and/or written-word storytelling, among various other forms. For example, audio compositions underlying storytelling can augment the experience by conveying richer information to a user, for instance by aurally conveying the mood, tone, or style of a story (or portion thereof). This contextual information can encapsulate various different elements or themes of a written work, whether it be the rapid and anxious tone of a suspenseful event, or the calm and quiet moments of a sunny day in nature. Using audio compositions to aurally convey contextual or other related information for a textual work can improve comprehension and focus for a reader or listener. For example, aurally conveyed contextual information corresponding to a textual work may better engage a reader with the storyline, by deepening the reader's connections to the events of a particular scene, character, etc. Augmenting a first information-conveying modality (e.g., text) with contextual information presented via a second information-conveying modality (e.g., audio composition or soundscape) can provide a more immersive and captivating experience for users.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below:

Disclosed are systems, methods, apparatuses, and computer-readable media for audio processing and audio stem generation, using incremental learning to generate additional audio stems with audio processing operations based at least in part on attributes of the input audio stem(s) and/or attributes of a downstream automatic soundscape composition process. According to at least one illustrative example, a method for processing one or more audio samples (e.g., audio stems) is provided. The method may include: obtaining a set of input audio stems, the set of input audio stems comprising a selected subset of a plurality of audio stems: obtaining configuration information corresponding to audio processing operations for the set of input audio stems: generating, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information: receiving information indicative of user feedback ratings for each respective multiplied audio stem of the plurality of multiplied audio stems; and generating, using the audio stem multiplier engine, a second plurality of multiplied audio stems based on at least the user feedback ratings and one or more of the set of input audio stems or the plurality of multiplied audio stems.

In another illustrative example, an apparatus for processing one or more audio samples is provided that includes at least one memory and at least one processor coupled to the at least one memory. The at least one processor is configured to and can: obtain a set of input audio stems, the set of input audio stems comprising a selected subset of a plurality of audio stems: obtain configuration information corresponding to audio processing operations for the set of input audio stems: generate, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information; receive information indicative of user feedback ratings for each respective multiplied audio stem of the plurality of multiplied audio stems; and generate, using the audio stem multiplier engine, a second plurality of multiplied audio stems based on at least the user feedback ratings and one or more of the set of input audio stems or the plurality of multiplied audio stems.

In another illustrative example, a non-transitory computer-readable storage medium comprising instructions stored thereon which, when executed by at least one processor, causes the at least one processor to: obtain a set of input audio stems, the set of input audio stems comprising a selected subset of a plurality of audio stems: obtain configuration information corresponding to audio processing operations for the set of input audio stems: generate, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information: receive information indicative of user feedback ratings for each respective multiplied audio stem of the plurality of multiplied audio stems; and generate, using the audio stem multiplier engine, a second plurality of multiplied audio stems based on at least the user feedback ratings and one or more of the set of input audio stems or the plurality of multiplied audio stems.

In another illustrative example, an apparatus is provided. The apparatus includes: means for obtaining a set of input audio stems, the set of input audio stems comprising a selected subset of a plurality of audio stems: means for obtaining configuration information corresponding to audio processing operations for the set of input audio stems: means for generating, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information: means for receiving information indicative of user feedback ratings for each respective multiplied audio stem of the plurality of multiplied audio stems; and means for generating, using the audio stem multiplier engine, a second plurality of multiplied audio stems based on at least the user feedback ratings and one or more of the set of input audio stems or the plurality of multiplied audio stems.

In some aspects, a quantity of audio stems included in the plurality of multiplied audio stems is greater than a quantity of audio stems included in the set of input audio stems.

In some aspects, a method further comprises outputting the plurality of multiplied audio stems for play back to a user; and receiving the information indicative of the user feedback ratings based on outputting the plurality of multiplied audio stems for play back.

In some aspects, the user feedback ratings comprise a positive user feedback rating or a negative user feedback rating for each respective audio stem variation included in the plurality of multiplied audio stems.

In some aspects, applying the one or more audio processing operations to generate a respective multiplied audio stem includes: receiving configuration information indicative of a desired tone-shaping adjustment: processing, using a machine learning tone-shaping model, at least one input audio stem of the set of input audio stems to generate a corresponding one or more tone-shaped audio stems as output, wherein the machine learning tone-shaping model process the at least one audio stem based on the desired tone-shaping adjustment; and outputting the corresponding one or more tone-shaped audio stems within the plurality of multiplied audio stems.

In some aspects, the set of input audio stems includes one or more multiplied audio stems generated as output in a previous processing round performed by the audio stem multiplier engine.

In some aspects, the configuration information for the set of input audio stems includes the user feedback ratings information for each of the one or more multiplied audio stems generated as output in the previous processing round.

In some aspects, the configuration information for the set of input audio stems is indicative of a selected one or more audio processing operations or audio effects processing modules to be applied by the audio stem multiplier engine to generate the plurality of multiplied audio stems from the set of input audio stems.

In some aspects, the selected one or more audio processing operations or audio effects processing modules are selected based on one or more user inputs or based on user feedback ratings associated with a previous processing round performed by the audio stem multiplier engine.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof, which are illustrated in the appended drawings. In the drawings, like reference numbers can indicate identical or functionally similar elements. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an example architecture of a network for implementing a method for creating a personalized sound environment for a user, in accordance with some examples;

FIG. 2 is a flow diagram illustrating an example of a process of automatic composition that may be used to create a personalized sound environment for a user, in accordance with some examples:

FIG. 3 is a flow diagram illustrating an example of sound library inputs of one or more audio stems for sequencing sounds for presentation to the user, in accordance with some examples:

FIG. 4 is a block diagram illustrating an example architecture of an audio processing system that can be used for the automatic generation and multiplication of audio stems, in accordance with some examples:

FIG. 5A is a diagram illustrating a first example of audio stem multiplication, in accordance with some examples:

FIG. 5B is a diagram illustrating a second example of audio stem multiplication, in accordance with some examples:

FIG. 6 is a flow chart illustrating an example of a process for processing one or more audio samples, in accordance with some examples:

FIGS. 7A-7C are diagrams illustrating examples of neural networks, in accordance with some examples; and

FIG. 8 is a block diagram illustrating an example of a computing system for implementing certain aspects described herein.

### DETAILED DESCRIPTION

Various example embodiments of the disclosure are discussed in detail below. While specific implementations are discussed, it should be understood that these are described for illustration purposes only. A person skilled in the relevant art will recognize that other components and configurations may be used without parting from the spirit and scope of the disclosure. Thus, the following description and drawings are illustrative and are not to be construed as limiting the scope of the embodiments described herein. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments. Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein. It should be further noted that the description and drawings merely illustrate the principles of the proposed device. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed device. Furthermore, all statements herein providing principles, aspects, and embodiments of the invention, as well as specific examples thereof, are intended to encompass equivalents thereof.

### Overview

Systems, apparatuses, methods (also referred to as processes), and computer-readable media (collectively referred to herein as “systems and techniques”) are described herein for audio processing and automatic audio stem multiplication and generation. In one illustrative example, the systems and techniques described herein can use incremental learning to generate additional audio stems (e.g., automatically multiplied audio stems based on an input set of one or more audio stems). For instance, incremental learning can be applied over a plurality of iterative rounds of audio stem multiplication, wherein user feedback and/or other user input(s) indicative of a subset or selection of a plurality of output stems for the current iterative round are used as an additional input for generating a plurality of output stems for the next iterative round.

An “audio stem” (also referred to herein as a “stem”) can be a type of audio sample. For instance, audio stems may refer to individual tracks or channels in an audio file or audio data (e.g., a piece of music, an audio project, etc.) that can be isolated and separated from the complete mix. For instance, the audio file of a song can include separate stems for the different tracks or layers that are included in the audio file-one or more audio stems can correspond to one or more tracks or layers of vocals, one or more audio stems can correspond to one or more tracks or layers of guitar, one or more audio stems can correspond to one or more tracks/layers of drums, one or more audio stems can correspond to one or more tracks/layers of bass, one or more audio stems can correspond to one or more tracks/layers of keyboard or piano, etc.

In some aspects, audio stems may correspond to the individual elements of a song or other mixed audio data. By having access to the individual elements of a song (e.g., in the form of its constituent audio stems), each element can be manipulated separately, for instance to create a new version of the song or track, etc. Audio stems may also provide the base unit over which mastering and/or other audio processing operations, audio effects, etc., are applied to obtain the desired final presentation of the song or audio track that comprises a plurality of audio stems. In some embodiments, audio stems can be provided and/or obtained as individual audio files that are arranged, compiled, combined, etc., into a larger audio track that comprises a plurality of audio stems. For instance, a plurality of audio stems may correspond to a plurality of individual audio files, such as .wav files, etc. In some cases, the systems and techniques described herein may access raw or underlying individual audio stems directly (e.g., may access a database containing a plurality of individual audio files, each respective individual audio file corresponding to a particular audio stem). In some examples, the systems and techniques may receive as input an audio data that comprises, contains, or otherwise utilizes multiple stems, and the systems and techniques may obtain the audio stems by extracting the individual audio elements (e.g., the different audio stems) from the single input of audio data. In some cases, audio stems may each have the same length (e.g., a pre-determined or otherwise configured length). In some examples, audio stems may vary in length. In some examples, the audio stems that correspond to the same song or input audio data may each have the same length (e.g., each respective audio stem included in a song can have the same length, which is the length of the song audio track: etc.).

As noted previously, a song or other multi-track audio composition (e.g., multi-track audio data) can be generated by simultaneously outputting various different audio stems (and combinations thereof) at different moments in time. Accordingly, audio stems can be used as the input(s) to audio composition processes and techniques, including manual audio composition, automatic audio composition, and combinations of manual and automatic composition. In one illustrative example, the number of possible audio compositions that can be generated using a fixed set of audio stems as input (e.g., a fixed or static quantity of audio stems may be used to generate audio compositions) may be approximated as also being a generally fixed quantity, with a dependency on the quantity of input audio stems that are available for the composition. In other words, the greater the number of different audio stems that are included in the domain of available inputs to an audio composition process, the greater diversity of possible audio compositions that may be generated as output-increasing the input space of different individual audio stems can be seen to also increase the output space of potential or possible different audio compositions that are combinations of various audio stems.

In one illustrative example, the systems and techniques described herein can be used to automatically increase (e.g., multiply) a quantity of audio stems, given an input set of one or more individual audio stems. In other words, the systems and techniques can be used to multiply a first quantity of input audio stems into a second quantity of output audio stems, where the second quantity is greater than the first quantity. In some cases, each output audio stem (e.g., also referred to as a “multiplied audio stem”) can be a different variation of one or more input audio stems. In some aspects, the output audio stems are each different from the underlying input audio stems in one or more characteristics, parameters, dimensions, etc. That is, in some aspects, the set of output audio stems are based on the input audio stems, but do not include the original input audio stems themselves. In other examples, the set of output audio stems can include the original input audio stems themselves and can further include the plurality of multiplied audio stems that are variations of the input audio stems.

In some embodiments, one or more user inputs, parameters, characteristics, values, etc., can be specified and used to perform the audio stem multiplication. For instance, when the audio stem multiplication described herein is used in the context of automatic soundscape generation (e.g., automatic soundscape generation performed as a downstream process, based on using the multiplied audio stems as input(s)), an audio stem multiplication engine can receive as input a set of input/original audio stems that are to be multiplied, and can receive configuration information for generating the multiplied audio stems as variations of/based on the input audio stems. For instance, the configuration information can be indicative of a desired mood for the multiplied audio stems (e.g., relax, focus, sleep, etc.). The configuration information can be indicative of a desired tone, pitch, beats per minute (BPM), etc., and various other sound processing parameters that can be associated with processing audio samples, audio stems, etc. The audio stem multiplication engine can automatically generate a plurality of multiplied audio stems as output, wherein each multiplied audio stem comprises a variation or processed version of an input audio stem generating according to at least a portion of the configuration information. The multiplied audio stems can be output to a user of the audio stem multiplication engine described herein for feedback. For instance, the user may indicate a positive or negative ranking/feedback of the respective multiplied audio stems, where positive ranked multiplied stems are kept and negative ranked multiplied stems are discarded, etc. In some embodiments, the user feedback and/or selection information applied over the set of multiplied audio stems can be used to drive an incremental learning process, where further rounds or iterations of audio stem multiplication are performed based at least in part on the user preferences indicated by the user feedback and selections made in one or more previous rounds of the audio stem multiplication process.

Further aspects of the systems and techniques will be described with respect to the figures.

### Example Embodiments

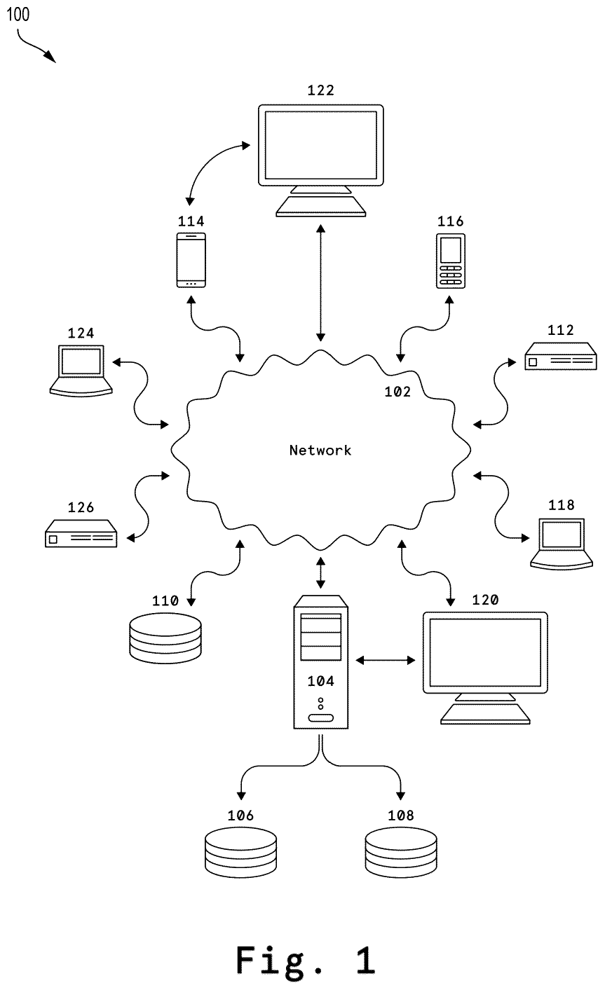

Described below with respect to FIGS. 1-3 are examples and details of an illustrative automatic composition system and/or process that can be configured to generate personalized sound environments (also referred to herein as “soundscapes”) for a user, based on one or more audio stems generated using the presently disclosed audio stem multiplication systems and techniques.

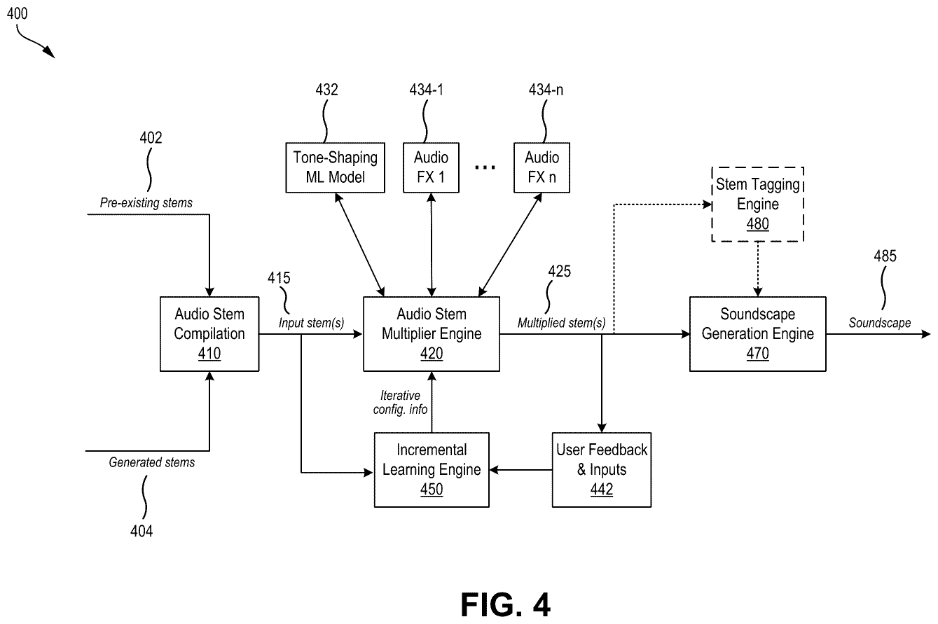

The audio stem multiplication systems and techniques disclosed herein are subsequently discussed with respect to FIGS. 4-6.

Example Soundscape Generation and or Audio Composition from Audio Stems

Referring first to FIG. 1, depicted is an exemplary architecture of a network and system that can be used to implement aspects of the present disclosure. For instance, the sounds system 100 can be used to perform the automatic generation and multiplication of audio stems using incremental learning, as described herein. In some embodiments, the sounds system 100 and/or the audio stem multiplier engine(s) described herein can be associated with a system and/or process for generating a personalized sound environment for a user, where the personalized sound environment is generated based at least in part on one or more automatically generated or multiplied audio stems from the presently disclosed audio stem multiplier engine(s). For instance, the presently disclosed audio stem multiplier engine(s) can be provided as an upstream module or component that outputs the automatically generated and/or multiplied audio stems to a downstream automatic composition engine.

The network 102 across which transmissions of information, data and sound in exemplary embodiments occur, can include any private or public, wired or wireless network, including but not limited to Local Area Networks, Wide Area Networks, the Internet, the World Wide Web, radio frequency (RF), Bluetooth, and a Cloud-based network. There is shown an exemplary network sound server 104 and one or more databases and/or storage devices 106, 108, and 110. There may be more servers, more databases, and more storage devices 110 than those displayed in FIG. 1, with the servers minimally configured with memory, storage media, at least one processor, communication resources, and with databases and files being external to or integrated with the servers. There are one or more user devices 114-120, platforms, or channels, for utilizing the personalized sound system and for the presentation of personalized sounds to individual users. For convenience and not limitation, users are collectively represented as a smart phone 114. The system 100 can affect the analysis of sensor data, environmental information, user input, and library sounds; and transmission of personalized sounds to users of devices 114 through the network sound server 104 and network 102. The personalized sound system 100 extends to software, programs, and routines within storage media on each of the user devices and network server.

The user devices 114 for receiving, playing, and displaying the personalized sounds are representatively shown as a smart phone 114, a cell phone 116, a portable tablet or laptop computer 118, and a desktop computer 120. Examples of user devices 114 include, but are not limited to, wireless user equipment and communication devices, such as, for example, mobile telephones, smart phones, personal digital assistants, electronic readers, portable electronic tablets, personal computers, and laptop computers. Each representative user device 114 minimally comprises a processor, a memory coupled to the processor, computer readable media, facilities for entering information into the user device 114, and an antenna or other wired or wireless connection device coupled to the processor for receiving and transmitting information, messages, commands or instructions, and sounds. A display on the user device 114 can include touch screen technology for the entry of user information required by the system and information related to the environment, including location, of the user. The information can be entered, for example, in text form or by touching action buttons displayed on the screen or integrated with the body of the user device 114. Alternately, user entry of information can be through use of a physical or touch screen keyboard or by voice.

Output and readings from a plurality of sensor devices 112 are received by the sound system 100, and particularly by the network sound server 104. The information and data received from the sensor devices 112 include information related to the user and the environment in which the user is situated. This sensor data is utilized to assist with selection of sounds to present to the user, as discussed in more detail below:

The sounds system 100 alternately includes one or more receiver devices 122 and 124 for receiving information and commands from the user devices 114. These receiver devices are collectively represented as a computer 122. The receiver devices 122 can be any type of computing device having communications and display facilities in the same manner of the user devices 114. One to many receiver devices 122 are in communication with the system 100 and can communicate from a plurality of different devices and via a plurality of different communication protocols, as described above regarding the remote user device 114. While FIG. 1 shows all communications being directed to the network sound server 104, exemplary embodiments are not so limited; and communications can be provided directly through the network 102 between the user devices 114 and the receiver devices 122 for receiving information from the user devices 114 and presenting sounds to the user devices 114.

Exemplary embodiments are implemented on the network sound server 104 and on the computers of the user devices 114 and, alternately on the receiver devices 122. Computer readable and executable instructions, or software, are provided for directing the processing of the computers of the exemplary devices 114, 122, and 104, including processing the steps of exemplary embodiments of the sound system 100. The computer executable instructions, when executed by the computers 114, 122, and 104 and/or the processors associated with each of said computers, provide for the presentation of personalized sounds to the user devices 114 and the control of the user's environment.

One or more storage devices 106, 108, and 110 are provided for storage of information regarding resources available for composing sounds to be presented to the user devices 114. This information includes, but is not limited to, user profiles, note sequence files, raw audio files, files of single note sounds, sound tones, and sounds from musical instruments. The stored information can also include past sounds presented to the user. One or more (or all) of the stored audio samples or other audio data may comprise audio stems. For instance, one or more (or all) of a note sequence file, a raw audio file, a file or single not sounds, sound tones, sounds from musical instruments, etc., may comprise at least one respective audio stem. The storage devices can retain data and information as files, libraries, and directories, for example. Access to and usage this information to compose sounds to be presented to the user is discussed in more detail below:

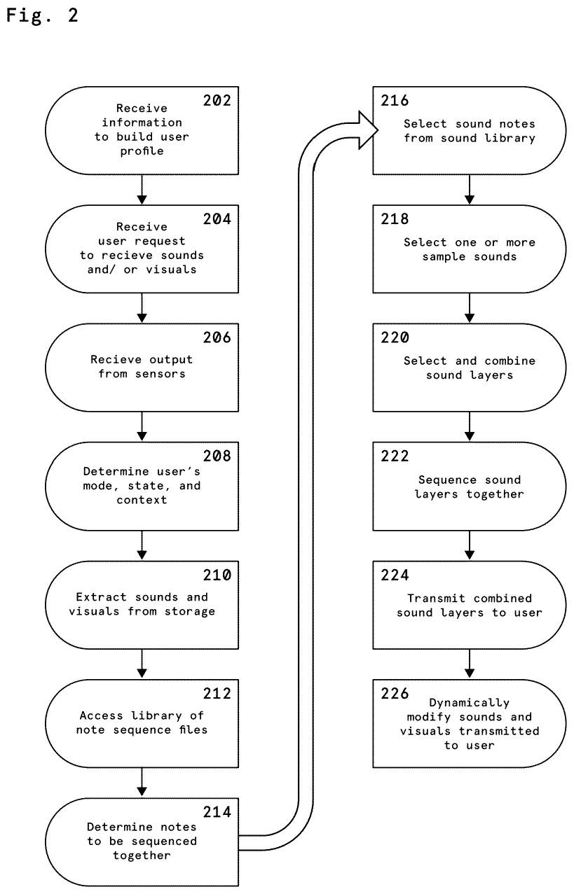

Computer readable media includes computer storage media, which includes volatile and non-volatile media, removable and non-removable media implemented in any method or technology for the storage of information, including computer readable instructions, data structures, display templates, and responder information. Computer storage media includes, but is not limited to magnetic media (e.g., a hard disk), non-transitory memory, optical media (e.g., a DVD), memory devices (e.g., random access memory), and the like. In some embodiments, computer readable instructions are configured such that, when executed by a processor, the instructions cause the processors of the exemplary computers 114, 122, and 104 to perform steps described below of the sound system (e.g., steps described below with reference to the flow chart shown in FIG. 2). In other embodiments, the exemplary computers 114, 122, and 104 are configured to perform steps described below without the need for instructions. Therefore, the features of the present embodiments described herein may be implemented in any suitable combination of hardware and/or software. Computer storage media does not include a carrier wave or any other propagated data signal.

In some examples, the sounds system 100 can automatically compose personalized soundscapes, based on one or more sensor inputs, for various modes and purposes, which can include but are not limited to sleep, focus, exercise, etc. In some examples, the automatic composition of personalized soundscapes includes an automatic and/or dynamic (e.g., real-time) modification of a personalized soundscape that was previously generated or composed according to the system and method described herein. In some embodiments, the methodology for generating personalized sound environments for users is based on circadian rhythms, pentatonic scale, and sound masking. The generated sounds automatically adapt, without any user input, to different inputs, such as time of day, weather, heart rate, and location. The process begins with the user opening an application on the user's device. The user's device is preferably a portable device connected to a network such as the Internet. Automatic sound composition and automatic sound stem generation and/or multiplication can also be performed on a user device (e.g., user computing device, such as a smartphone, mobile computing device, etc.) that is not connected to a network or on a user device that is not portable, with local storage files, media, and software, etc.

Referring now to FIG. 2, depicted is a flowchart of a method for composing and presenting personalized sounds to a user, based on that user's environment and state. The present invention provides a method for creating a personalized environment to address a person's individual environment, mode or needed mode, state, and context, including receiving and analyzing sensor data representative of a user's environment and state and utilizing the analyzed data with libraries of sounds (e.g., sound/audio stems, etc.) to compose and present to the user a dynamic, personalized stream of sounds. The sounds to be presented to the user are comprised of a created composition of notes, sounds, and instrument sounds (e.g., audio stems, etc.) in multiple combinations and layers. This sounds presentation is in contrast to presenting known music scores or a music playlist for user selection and/or listening. Hereinafter, the steps of this method will be described in detail.

At step 202, the application presents a number of questions and categories to the user to establish a user profile, the profile may include user preferences, such as related to music, genre, sound, activities, vocation, avocations, images, colors, and weather. The system builds a profile of the user based on the received user information in response to the questions and selected categories. The user can change the profile at will upon identified authorization.

At step 204, a request is received from the user to receive sounds from the system, based on the user's environment and state. The request can also indicate particular user-related environmental or state information, such as the user requesting sounds for a certain period of time and/or the user expressly requesting sounds to provide relax, focus, or activity modes for the user. Alternately, the user's profile can provide this information. Also, the user can establish a profile that instructs the system to automatically initiate presentation of sounds/at a particular time of day or day of the week, or upon determining a particular state of the user, such as a high heartrate or blood pressure, or prolonged driving.

At step 206, the application receives the outputs from sensors 112 and from the user; and from those outputs can determine an actionable description for the user. Such an actionable description includes a user mode, a user state, a user context, and a user physical environment. Based on the user's determined actionable description, the system can determine the user's status and can determine sounds to positively impact the user. The sensors 112 can provide location information, such as from a global positioning receiver (GPS) on the user's device 114. The received GPS information can be continual such that the system can determine whether the user is stationary, walking, running, or driving. With this information, the system can partially determine the sounds to present to the user. For example, a stationary state of the user suggests the user may be at work; and the system selects focus-related sounds for presentation. Similarly, if the user is determined to be walking or running, energizing (i.e., upbeat) sounds can be selected for presentation. Alternately, the user may have established a profile indicating that relaxing sounds are preferred for walking. If the user is determined to be driving, based on the speed and the path whereby the GPS signals are changing and by traffic information input, a combination of relaxing and focusing sounds/music can be selected for presentation.

Further, the location information can determine to which channel or platform to transmit the sounds/to the user (e.g., such as the user's work computer, the user's mobile phone, or the user's home computer or smart speaker system, etc.). The system is adaptable to deliver personalized sounds to a user over a network or a cloud-based service regardless of where the user is located or moving toward. Parameters can be established to weight the relative importance and impact of the outputs from the sensors based on the user profile and preferences, perhaps, for example, giving more significance to heartrate and blood pressure for an older user.

The sensors 112 can also provide the physical information, such as the heartrate and/or the blood pressure, of the user. The heartrate information, coupled with other sensor data, helps the system determine the user's state and the user's changing state (such as when the heartrate increases or decreases). The system can compare the user's heartrate against a medical standard for persons of the user's profile, such as age, weight, and exercise regiment, or from an accumulated history of the user's heartrate. This comparison can suggest the user is more or less stressed, is engaged in more or less strenuous activity, is more or less relaxed; and the system can dynamically adjust the sounds presented to the user to relax the user, cause the user to better focus, to help energize the user, and to help the user fall asleep. Similarly, the user's blood pressure, if elevated compared to a standard or the user's history, can signal a stressful condition for which soothing or relaxed sounds should be presented.

Other sensors 112 provide weather data, knowing that high winds, excess temperatures (high or low), bright or diminished light, and rapidly changing barometric pressure can affect an individual's mood and stress level. In recognition of the environment in which the user is functioning, the system can provide sounds to counter the user's environmental effect, such as providing energizing sounds in response to low light. Further sensors 112 provide data regarding the user's steps, cadence, and movement type. Such information helps determine what the user is doing, in addition to the more global GPS data. This information can help specifically determine whether the user is walking in a relaxed manner, rushing to get to an appointment on time, climbing stairs, sitting at a desk, or running. This information, coupled with time and date information from a clock sensor can help determine when the user is moving related to work, running in the morning or evening, or sitting at home relaxing. The various sensor information helps the system determine the environment in which the user is functioning and the state of the user-all performed dynamically without expressly asking the user to provide this information. The system responds to this information by automatically selecting sounds for improving the user's circumstance, by providing relaxing, motivating, energizing, on the go, etc., sounds.

The received sensor information can be stored in a storage device 106, 108, or 110, along with determined sounds presented to the user for a library of data for subsequent analysis and presentation to the user. For example, the stored heartrate data can be compared to the user's current heartrate to determine whether the user's current heartrate is elevated or low: Further, past presented sounds can be labeled for subsequent presentation under similar user states if the past presented sounds were designated at being successful as, for example, providing relaxing, motivating, soothing, or energizing sounds, as determined by subsequent user comment or behavior.

At step 208, an actional description of the user is determined based on the user input, the user profile, and the sensor outputs. The user's mode, state, and/or context is determined based on analysis of the received sensor information and, alternately, information in the user's profile. As discussed above, the analyzed sensor data and profile data can determine whether the user is stressed, is relaxed, is at work, is at home, is at the gym, needs to relax, needs to focus, needs to be energized, and so on. Additionally, the user can provide input to specify her state or context, can permit the system to provide sounds appropriate to her state or context, or can expressly request the type of sounds to be presented. The state of the user relates to mental and physical condition of the user, such as stressed, relaxed, asleep, running, needing to focus, and so on. The context of the user relates to the environment of the user, such as whether the user is at work, outside, or outside: what the weather is for the user, what the date and time of day is, and what is the lighting level and the temperature of the user's environment. The combined determined mode, state, and context of the user can be referred to as the user status.

At step 210, based on the user's determined or specified status, the system extracts sounds (e.g., audio stems) from a storage library or libraries (e.g., audio stem libraries, databases, etc.) for creating sounds for presentation to the user, based on the user's profile and specified input.

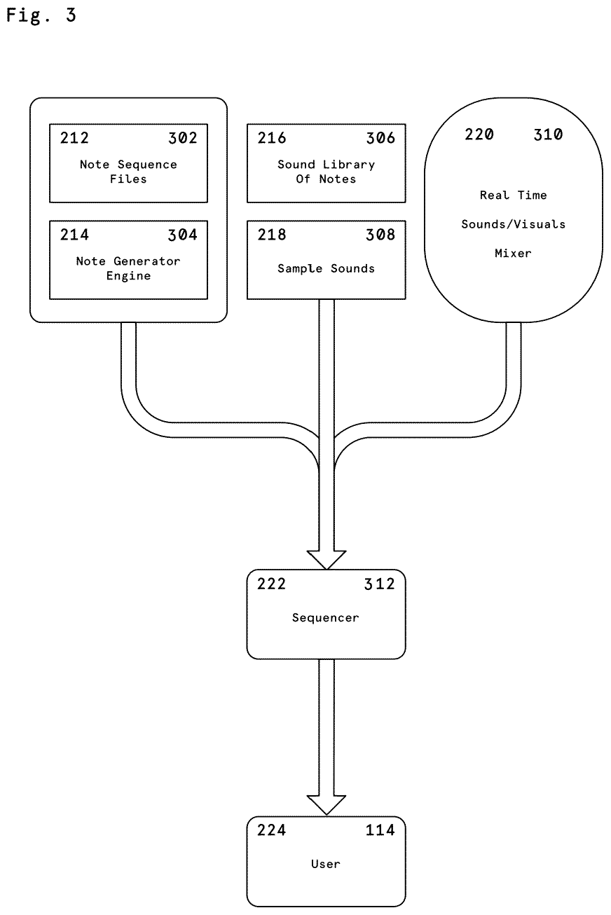

Referring also to FIG. 3, which is a flow diagram illustrating an example of sound library inputs of one or more audio stems for sequencing sounds for presentation to the user, and as explained above regarding step 202, raw inputs can be received from the user to be processed and create a user profile. From the user profile, user input, and/or the sensor information, a motion and mode of the user is determined. From this motion and mode, the sound engine composes a dynamic soundscape using a unique granular system in which smaller sound sections are sequenced together in order to create sound phases which define a particular user activity, user state and user model. These sound phases, in turn, may then compose much larger and dynamic soundscapes of indefinite length when the user's condition changes according to conditional rule sets.

Firstly, sounds sections comprising layered sounds allow for the control of sound development in a soundscape on a more granular scale. For example, small changes in a user's heart rate may subtly change the tempo. Sections are also responsible for structural composition and development within a phase, such as to allow for introductions, as well as body and bridge sound sections. For instance, introductions to a particular phase may comprise a single melody or progression of chords to garner the listener's attention and set the tone of the particular phase. A bridge may tie together two contrasting sections of a phase, whereas the phase body is generally a recurring section. Altogether, this creates a more homogenous soundscape adapted to a particular set of conditions.

In the creation of these smaller sound sections, the system at step 212 accesses a library of note sequence files 302 divided by intensity, for example as illustrated in the example flow diagram of FIG. 3, illustrating the example of sound library inputs of one or more audio stems for sequencing sounds for presentation to the user. The note sequence files are random musical scores of note sequences, typically of 10-20 second duration that can be repeated continuously until the presentation is terminated by time, by a determined change user state or context, or by user request. The selected score(s) is selected or created by the software or firmware of the note generator engine 304, which also determines the sequence of the notes and the duration of the notes sequences, based on the determined user's state or context. At step 214, the note generator 304 additionally determines, based on rules and past successful presentations to the user, which notes can be sequenced together or one after another. For example, notes of extremely differing pitches, tone, or sound are not sequenced together to provide relaxing or soothing sounds: whereas such contrasts can be useful to provide energizing sounds. Based on which notes are known to work together under the rules and past presentations, the sound generator 304 can create sequences of up to 40 notes which can be presented repeatedly or can be re-sequenced to provide a presentation variety or in response to changing sensor information.

The third source of sounds is selected at step 216 from a sound library 306 comprised of raw audio files of single notes. Again, the determined state, context, and/or user profile will determine the particular notes. For example, notes at the lower end of the musical scale can be more soothing and are selected by the system for presenting soothing or relaxing sounds. The various notes in the musical scale can be chromatically mapped to instruments sounds for having available instrument sounds for each scaled note.

A fourth source of sounds is selected at step 218 from a library of sample sounds 308, based on the determined user state, context, and/or profile. These sample sounds can include sounds from nature, white noise sounds, vocals, sounds from musical instruments, etc. These sounds could be up to several minutes in duration, and again are selected based on the determined state, context, and/or user profile. For example, a trumpet sound can be selected for a more energized sound for presenting to a user who is running or needs motivation. The sounds from multiple samples can be selected for presentation to a user.

Each of the note sequences and notes from steps 212-216 can be viewed as a layer of sounds which form the sound section, with one or more layers being presented to the user. Additional layers are available by applying the note sequences and notes from steps 212-216 to the selected instruments of step 218. At step 220, particular sound layers can be selected and combined by a real time mixer 310 for presenting sounds to the user. The particular layers are selected based on a set of rules guiding the selection such that, as discussed above, the particular selected notes and instruments are appropriate for the determined user mode, state, user context, or user preferences and profile. Layers are also selected such that the layers of the combined output do not clash with each other in terms of tempo and intensity: The selected layers are sequenced together at step 222 for presentation to the user on the user device 114.

At step 224, the combined layers of sounds are presented to the user for listening by the user. The system can also determine the volume by which the sounds are to be presented to the user. The user device 114 can include a microphone to detect a single sound, a combination of sounds, a combination of sounds and music, and a combination including human speech. For example, the microphone can be utilized to measure sound levels in the user's space and react to sudden volume changes, either raising or lowering the sounds volume to permit continued listening by the user. A detection of a new human voice can trigger a reduction in the sounds volume to permit the user to conduct a conversation without being distracted by the presented sounds.

Changes in user state, user environment and user mode underly shifts between phases. At step 226, the system dynamically determines that information received from one or more sensors has changed and warrants a change in the sounds being transmitted for presentation to the user. For example, the location of the user has changed, and the GPS data shows the user driving from her gym to her home. Accordingly, the system changes the sounds to be more focused and relaxed, to address the attention the user needs for traffic and for preparing for a relaxed time at home after working out. Steps 210-226 can be performed automatically to generate an automatic soundscape from one or more audio stems, with and/or without human input, based at least on the determined user state and context.

### Audio Stem Multiplication and Audio Stem Multiplier Engine

As noted previously, systems and techniques are described herein that can be used to perform audio stem multiplication for one or more input audio stems. In one illustrative example, an audio stem multiplication engine (also referred to as an “audio stem multiplier,” an “audio stem multiplier engine,” and/or a “multiplier engine,” etc.) can be used to automatically generate a plurality of multiplied (e.g., output) audio stems that correspond to the one or more input audio stems. For instance, each respective multiplied audio stem generated as output by the multiplier engine can be a different variation of an input audio stem, can be generated as a new audio stem that shares one or more characteristics or properties with an input audio stem, etc.

FIG. 4 is a block diagram illustrating an example architecture of an audio processing system 400 that can be used for the automatic generation and multiplication of audio stems, in accordance with some examples. For instance, the audio processing system 400 can include an audio stem multiplier engine 420 that can be configured to generate a plurality of multiplied audio stems 425 as output, based on receiving one or more input audio stems 415 as input. In some embodiments, the plurality of multiplied audio stems 425 generated as output by the multiplier engine 420 can be provided to a soundscape generation engine 470 that may generate one or more soundscapes 485 for a user (for instance, soundscape generation engine 470 can be the same as or similar to a soundscape generation engine used to implement one or more operations associated with generating a soundscape (e.g., soundscape 485 of FIG. 4) as described previously above with respect to FIGS. 1-3; etc.).

As noted previously, an “audio stem” (also referred to herein as a “stem”) can be a type of audio sample. For instance, audio stems may refer to individual tracks or channels in an audio file or audio data (e.g., a piece of music, an audio project, etc.) that can be isolated and separated from the complete mix. For instance, the audio file of a song can include separate stems for the different tracks or layers that are included in the audio file-one or more audio stems can correspond to one or more tracks or layers of vocals, one or more audio stems can correspond to one or more tracks or layers of guitar, one or more audio stems can correspond to one or more tracks/layers of drums, one or more audio stems can correspond to one or more tracks/layers of bass, one or more audio stems can correspond to one or more tracks/layers of key board or piano, etc.

In some aspects, audio stems may correspond to the individual elements of a song or other mixed audio data. By having access to the individual elements of a song (e.g., in the form of its constituent audio stems), each element can be manipulated separately, for instance to create a new version of the song or track, etc. Audio stems may also provide the base unit over which mastering and/or other audio processing operations, audio effects, etc., are applied to obtain the desired final presentation of the song or audio track that comprises a plurality of audio stems.

In some embodiments, the input audio stems 415 utilized by the audio stem multiplier engine 420 can be obtained from an audio stem compilation process 410 and/or an audio stem compilation 410 comprising one or more databases or datastores of a plurality of individual audio stems. For instance, the input audio stems 415 shown in FIG. 4 can be obtained from the audio stem compilation 410 as pre-existing audio stems 402 (e.g., audio stems that are retrieved from an existing storage location, have been previously seen by the user and/or system, etc.), can be obtained as newly generated audio stems 404 (e.g., audio stems that are generated for the purposes of audio stem compilation 410 and/or providing the input audio stems 415 to the multiplier engine 420, etc.), and/or can be obtained as a combination of pre-existing audio stems 402 and newly generated audio stems 404. For instance, in some aspects audio stems can be provided and/or obtained as individual audio files that are arranged, compiled, combined, etc., into a larger audio track that comprises a plurality of audio stems. For instance, at least a portion of the plurality of audio stems associated with the audio stem compilation 410 (and/or at least a portion of the input audio stem(s) 415) may correspond to a plurality of individual audio files, such as .wav files, etc.

In some cases, the systems and techniques described herein may use the audio stem compilation 410 to access raw or underlying individual audio stems directly (e.g., may access a database containing a plurality of individual audio files, each respective individual audio file corresponding to a particular pre-existing audio stem 402). In some examples, the systems and techniques may receive as input (e.g., an input to the audio stem compilation 410 processing, etc.) an audio data that comprises, contains, or otherwise utilizes multiple stems, and the systems and techniques may obtain the audio stems by extracting (e.g., using the audio stem compilation 410 or other audio processing unit) the individual audio elements (e.g., the different audio stems) from the single input of audio data. In some cases, audio stems may each have the same length (e.g., a pre-determined or otherwise configured length). In some examples, audio stems may vary in length. In some examples, the audio stems that correspond to the same song or input audio data may each have the same length (e.g., each respective audio stem included in a song can have the same length, which is the length of the song audio track: etc.). For instance, the input audio stems 415 provided to the multiplier engine 420 may each have the same length, or may include audio stems having one or more different respective lengths, etc. For example, some or all of the input audio stems 415 (and the output, multiplied audio stems 425) may be associated with a pre-determined or configured stem length value, such as 5 seconds, 10 seconds, 15 seconds, etc. In some examples, some or all of the input audio stems 415 (and the corresponding output, multiplied audio stems 425) may be associated with a length that is equal to the larger song or multi-track audio file or composition from which the original input audio stem 415 was obtained or derived (e.g., a 3-minute song can include a 3-minute vocals stem, a 3-minute piano stem, etc.).

As noted previously, a song or other multi-track audio composition (e.g., multi-track audio data, such as the soundscape 485) can be generated by simultaneously outputting various different audio stems (and combinations thereof) at different moments in time. Accordingly, audio stems 415 can be used as the input(s) to audio composition processes and techniques for implementing the soundscape generation engine 470, including manual audio composition, automatic audio composition, and combinations of manual and automatic composition. In one illustrative example, the number of possible audio compositions (e.g., soundscapes 485) that can be generated using a fixed set of audio stems as input to the soundscape generation engine 470 may be approximated as also being a generally fixed quantity, with a dependency on the quantity of audio stems that are available for the composition performed by soundscape generation engine 470). In other words, the greater the number of different audio stems that are included in the domain of available inputs to an audio composition process such as that performed by soundscape generation engine 470, the greater diversity of possible audio compositions (e.g., soundscapes 485) that may be generated as output-increasing the input space of different individual audio stems can be seen to also increase the output space of potential or possible different audio compositions that are combinations of various audio stems.

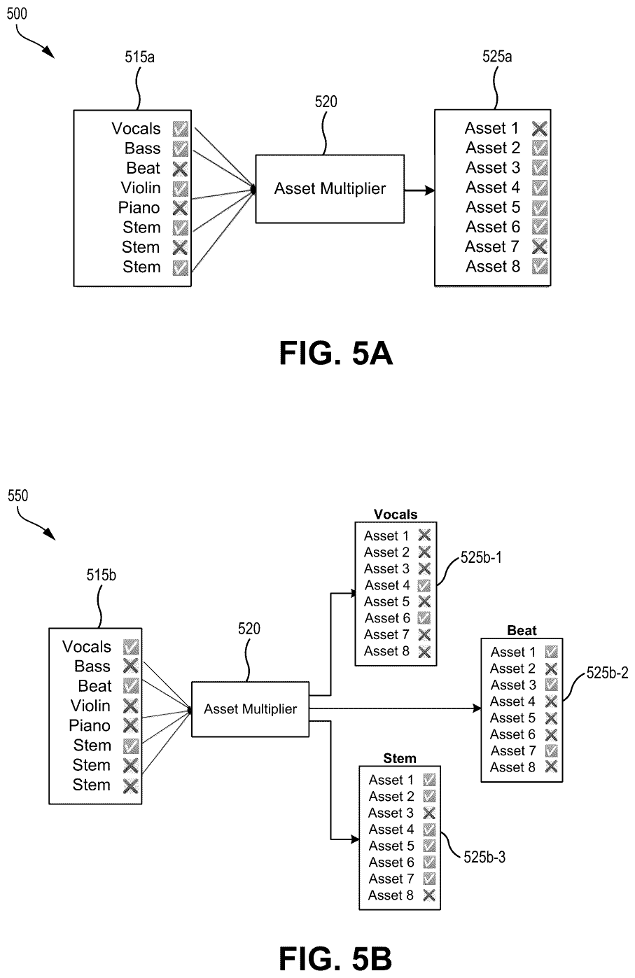

In one illustrative example, the systems and techniques described herein can be used to automatically increase (e.g., multiply) an input quantity of audio stems 415 into a larger (e.g., greater) quantity of output, multiplied audio stems 425. In other words, it is contemplated that in at least some embodiments, the number of multiplied audio stems 425 generated by the audio stem multiplier engine 420 is greater than (or equal to) the number of input audio stems 415 provided to the audio stem multiplier engine 420 for automatic multiplication. Various examples of the multiplication that may be performed for input audio stems 415 (e.g., one-to-one correspondence, one-to-many correspondence, etc.) will be described in greater detail below with respect to the examples of FIG. 5A and FIG. 5B.

In some cases, each output audio stem 425 (e.g., also referred to as a “multiplied audio stem”) can be a different variation of one or more stems from the set of input audio stems 415. In some aspects, the output audio stems 425 are each different from the underlying input audio stems 415 in one or more characteristics, parameters, dimensions, etc. That is, in some aspects, the set of output audio stems 425 are based on the input audio stems 415, but do not include the original input audio stems 415 themselves. In other examples, the set of output audio stems 425 can include the original input audio stems 415 themselves and can further include the plurality of multiplied audio stems that are newly generated as variations of the input audio stems 415.

In some embodiments, the input audio stems 415 provided to the audio stem multiplier engine 420 can be user-selected or can otherwise comprise a subset of audio stems selected from a plurality of available audio stems for the multiplier engine 420 (e.g., a selected subset of the plurality of audio stems available from the audio stem compilation 410, etc.). In some cases, the input stems 415 may be randomly selected from the plurality of available audio stems, or may be at least partially randomly selected from a filtered subset of the plurality of available audio stems. For example, audio stem compilation 410 can be filtered based on one or more configured audio stem parameters that are desired in the input stems 415, the output multiplied stems 425, or both. For instance, when the audio stem multiplier engine 420 is integrated into an audio processing workflow wherein the multiplied audio stems 425 generated by the multiplier engine 420 are used to generate a soundscape 485 using soundscape generation engine 470, the input audio stems 415 can be selected at least in part based on one or more functions or parameters (e.g., qualities, properties, etc.) of the desired sound for the final output soundscape 485.

In one illustrative example, a user input or configuration information can be provided by a user to the audio stem multiplier engine 420, indicative of one or more parameters for selected a desired set of input audio stems 415 for the presently disclosed audio stem multiplication. For example, the user input or stem selection information can cause the multiplier engine 420 to automatically select and obtain from the audio stem compilation 410 a set of input audio stems 415 that match a user-specified parameter such as “dreamy,” “beat-driven,” “ambient sound,” etc. In these examples, the audio stem multiplier engine 420 is itself configured to obtain the selected set of input audio stems 415 that will be used for audio stem multiplication. In another example, the audio stem multiplier engine 420) can instead receive the selected set of input audio stems 415 directly as input (e.g., such that the selection or filtering of the input audio stems 415 from the plurality of audio stems 410 is separated from and performed external to the functionality implemented by the multiplier engine 420).

In some aspects, the audio stem multiplier engine 420 can generate as output the multiplied audio stems 425 based on applying one or more audio processing engines, modules, sub-modules, etc., to the respective input audio stems 415. For instance, as will be described in greater detail below; the multiplied stems 425 can be generated from or based on the input stems 415 using one or more of a tone-shaping machine learning (ML) model 432, a first audio processing module 434-1 (e.g., “audio FX 1”), . . . , and/or an n^{th} audio processing module 434-n (e.g., “audio FX n”). In one illustrative example, the audio FX engines/modules 434-1, . . . 434-n can include various known and/or conventional audio processing effects that can be applied to audio stems or other audio samples or audio data, etc. For instance, the audio FX engines/modules 434-1, . . . 434-n can include, but are not limited to, adjusting various audio FX or processing effects (and/or individual parameters thereof) such as octave up, octave down, granules or granulator, delay, space (reverb), etc. This listing is provided for purposes of illustration and example, and is not intended to be construed as limiting.

In some aspects, the audio stem multiplier engine 420) can be associated with and/or can utilize one or more audio tone-shaping machine learning (ML) models 432 for generating the multiplied audio stems 425. A tone-shaping machine learning mode can be configured (e.g., trained) to modify properties of input audio such as the timbre or tone. For instance, the tone-shaping ML model 432 can be used to modify the timbre or tone of an input audio stem 415 signal, often to improve an aesthetic or perceived quality of the resulting output audio stem 425, and/or to match the output audio stem 425 to a particular, specified, or certain style of audio, etc. Machine learning-based tone shaping can be implemented as a class of neural effect, and the tone-shaping ML model 432 can be provided as a neural network (e.g., CNN, RNN, etc.) and/or, in at least some examples, a transformer-based machine learning model adapted for the sequential and time-dependent interrelation and nature of the input audio data. In some cases, the tone-shaping ML model 432 can utilize the audio waveform or spectrogram of the input audio stem 415 (or other audio input to the ML model 432) and applying multiple processing layers of transformations to the waveform/spectrogram to generate as output a modified waveform or spectrogram that has been tone-shaped according to a given criteria (e.g., adjust timbre or tone in a certain way: match or change the style of the input audio stem 415 to a different audio style for the output, multiplied audio stem 425: etc.)

In some aspects, a respective one of the multiplied stems 425 generated as output by the multiplier engine 420 can be created based on applying multiple audio FX effects 434-1, . . . , 434-n and/or applying the same effect multiple times, etc. Each of the audio FX processing modules 434-1, . . . , 434-n can have one or multiple adjustable parameters controlling the application of the effect on the input audio stem 415 being processed into a corresponding multiplied audio stem output 425. For instance, the audio stem multiplier engine 420 can generate multiplied stems 425 based on input stems 415 by adjusting audio FX parameters such as wetness (e.g., the mix or balance between a processed/effected signal and the original signal). In the context of an example where audio FX engine 434-1 corresponds to an octave down effect, the wetness value used to parameterize audio FX engine 434-1 for the octave down effect can determine the blend between the original pitch and the processed/effected pitch shifted one octave down, etc. In another example, one or more of the audio FX engine effects 434-1, . . . , 434-n can be associated with a probability parameter, where the probability value indicates the likelihood (e.g., probability) that the effect will be applied at any given time and/or to a given audio sample or audio stem input 415, etc.

In another illustrative example, the audio FX engine 434-1 may correspond to a granules or granulator audio processing effect, and the multiplier engine 420 can generate multiplied stems 425 by adjusting various audio FX processing parameter values such as duration (which in granular synthesis, can control the length of each grain or fragment of the sound being played, with a longer duration resulting in more recognizable fragments of the original sound and a shorter duration resulting in a more stuttering or choppy ‘textured’ sound): spread (e.g., controlling a range or distribution of grains): attack (referring to the time for each grain to increase to a peak volume, i.e., rate of increase or onset); release (referring to the time for the grain to decay or decrease back to silence or some other baseline): density (the quantity or number of grains played back simultaneously or in total for a multiplied stem 425 being generated, with larger density values creating a thicker or more layered sound); etc.

In another example, the audio FX engine 434-1 may correspond to a delay effect used to generate multiplied stems 425 as variations of input stems 415. For instance, the multiplier engine 420 can generate multiplied stems 425 by adjusting various audio FX processing parameter values for the delay effect, such as probability (probability of applying the effect): delay-left and/or delay-right (the delay time for left and right channels, respectively): feedback (controlling the amount or portion of delayed signal that is fed back into a delay input, resulting in repeated echoes for higher feedback values, etc.): wetness (controlling the mix between the original and delayed signals): etc.

In still another example, the audio FX engine 434-1 may correspond to a spatial processing or reverb effect applied by multiplier engine 420 to generate the multiplied stems 425 as variations of input stems 415. For instance, multiplier engine 420 can generate multiplied stems 425 by adjusting various audio FX processing parameter values for the spatial or reverb effect, such as probability (probability of applying the spatial effect): wetness (controlling the mix between the original and spatially processed signals): decay (determining the duration of the spatial effect or reverb, with a longer decay resulting in a more reverberant or echoing sound): size (determining a perceived size of the virtual space associated with the spatially processed or reverb sound signal); highcut (acting as a filter to reduce or cut out higher frequencies, thereby muffling the sound or making it sound more distant): etc.

In some aspects, the audio stem multiplier engine 420 can be implemented and/or configured to perform simultaneous (e.g., parallel) audio processing and audio stem multiplication for each respective original audio stem included in the selected set of input audio stems 415. For instance, if the selected set of input audio stems 415 includes three different audio stems, the audio stem multiplier engine 420 can generate a corresponding one or more multiplied audio stems 425 for each respective one of the three input audio stems 415. In such cases, the multiplier engine 420 can be configured to perform independent audio signal processing and multiplication for each respective stem included in the selected set of input stems 415. The independent processing for each input stem 415 may be performed in parallel or in series/sequentially, but may be configured to remain independent such that the variations applied to generate a first set of multiplied stems 425 for the first input stem 415 are not dependent upon or related to the variations applied by the multiplier engine 420 to generate a distinct second set of multiplied stems 425 for the second input stem 425, and vice versa: etc. In some cases, it is also contemplated that the multiplier engine 420 can be configured to perform batch processing for one or more, some, or all of the respective input audio stems included in the selected set of input audio stems 415, without departing from the scope of the present disclosure.

In some embodiments, the multiplied stems 425 can be generated by automatically selecting and applying one or more of the audio FX and/or audio processing modules and effects (e.g., associated with the multiplier engine 420) to each respective one of the input audio stems 415. In some cases, just as the user may provide selection information corresponding to a particular set of selected input stems 415 (based on desired characteristics or sound types for the multiplied stems 425 and/or a later generated soundscape 485 from the multiplied stems 425), the user may provide an initial configuration or indication of one or more sound processing and/or audio FX modules that may be applied by the multiplier engine 420 when generating the corresponding multiplied stems 425 as output given the selected set of input stems 415.

For instance, an initial user configuration of an input stem 415 within the audio stem multiplier engine 420 may cause the input stem 415 to have looping dreamy portions, portions of bass, etc. As was the case for user selection of the specific set of input audio stems 415 for multiplication, the initial user configuration for processing effects applied to the input stem(s) 415 can be based at least in part on a desired function or sound quality/characteristics for the multiplied stems 425 that are to be generated as output by the multiplier engine 420. For instance, an output function or use case for the multiplied audio stem 425 may be ‘Sleep’, in which case the audio processing operations applied by multiplier engine 420 can be configured and/or selected to output multiplied audio stems 425 that are homogenous and even. In another example, an output function or use case for a multiplied audio stem 425 may be ‘Relax, in which case the audio processing operations applied by multiplier engine 420 can be configured and/or selected to output multiplied audio stems 425 that may have more movement (relative to the ‘Sleep’ multiplied stems output), but never a beat or pulse. In still another example, an output function or use case for a multiplied audio stem 425 may be ‘Focus, in which case the audio processing operations applied by multiplier engine 420 can be configured and/or selected to output multiplied audio stems 425 that may be more beat-driven, stable, even, and/or homogenous (e.g., erase, chorus, verse structure, etc.).

In some embodiments, one or more user inputs, parameters, characteristics, values, etc., can be specified and used to perform the audio stem multiplication. For instance, when the audio stem multiplication described herein is used in the context of automatic soundscape generation (e.g., automatic soundscape generation performed as a downstream process, based on using the multiplied audio stems as input(s)), the audio stem multiplication engine 420 can receive as input a set of input/original audio stems 415 that are to be multiplied, and can receive configuration information for generating the multiplied audio stems 425 as variations of/based on the input audio stems 415. For instance, the configuration information can be indicative of a desired mood for the multiplied audio stems 425 (e.g., relax, focus, sleep, etc.). The configuration information can be indicative of a desired tone, pitch, beats per minute (BPM), etc., and various other sound processing parameters that can be associated with processing audio samples, audio stems, etc., using one or more of the tone-shaping ML model 432 and/or audio FX engines 434-1, . . . , 434-n as described above. The audio stem multiplication engine 420 can automatically generate a plurality of multiplied audio stems 425 as output, wherein each multiplied audio stem 425 comprises a variation or processed version of an input audio stem 415 generating according to at least a portion of the configuration information. In one illustrative example, the multiplied audio stems 425 can be output to a user of the audio stem multiplication engine 420 for feedback.

In one illustrative example, the multiplied stems 425 can be output to the user and user feedback or preference information can be solicited and/or obtained using a user feedback and input engine 442 that is associated with (and/or included in, implemented by; etc.) the audio stem multiplier engine 420. For instance, after the user's selected stems are sent into the multiplier engine 420 as the selected set of input stems 415, the audio stem multiplier engine 420 can be configured to generate one (or multiple) iterations of new functional stems from the selected set of input stems 415. In some embodiments, the multiplier engine 420 can generate a suggestion of 10-15 new variations of the input stem(s) 415 in the form of new processed audio stem files corresponding to each output multiplied stem 425. For instance, the input stem 415 may be a single stem uploaded by the user, and the output of multiplier engine 420 can be multiplied stems audio sample data 425 comprising 10-15 respective processed audio stem file variations of the single input stem, etc. Two input stems 415 may correspond also to a total of 10-15 total variations, or may correspond to a total of 20-30 new variations (e.g., 10-15 variations for each of the two input stems 415), and so on, etc.

The user can utilize the user feedback and input engine 442 to listen to each of the underlying audio assets generated for the multiplied stems 425 output by the multiplier engine 420. The user may provide feedback or user inputs for some, or all, of the multiplied stems 425, to a user interface, GUI, or other input means, etc., associated with the user feedback and input engine 442. For instance, the user may indicate a positive or negative ranking/feedback of the respective multiplied audio stems 425, where positive ranked multiplied stems are kept and negative ranked multiplied stems are discarded, etc. In some embodiments, the user feedback and inputs engine 442 can provide the user with an option to tweak each of the output stems generated by the multiplier engine 420 and included in the set of multiplied stems 425, based on adjusting one or more audio FX processing parameters of the respective audio processing sub-module(s) 434-1, . . . , 434-n applied by the multiplier engine 420 for the particular output stem 425 that is being edited by the user.

In some embodiments, the user feedback and/or selection information obtained at user feedback and inputs 442 for the set of multiplied audio stems 425 can be used to drive an incremental learning process of an incremental learning engine 450, shown in FIG. 4 as being associated with the audio stem multiplier engine 420. In one illustrative example, the user feedback information and incremental learning performed using incremental learning engine 450 can cause the audio stem multiplier engine 420 to perform further rounds or iterations of audio stem multiplication based at least in part on the user preferences indicated by the user feedback and selections made in one or more previous rounds of the audio stem multiplication process.

In some embodiments, the incremental learning engine 450 can be implemented using one or more machine learning networks, models, instances, etc. that are configured to predict (e.g., during inference using the trained ML model(s)) one or more audio signal processing adjustments that can be applied to an input audio stem and used to generate a multiplied audio stem 425 that will receive a positive feedback or rating from the user. For instance, in one illustrative example, the audio stem multiplier engine 420 may be configured (initially, or in the absence of the incremental learning engine 450) to randomly select only a portion of the overall length of an input audio stem 425 to be used for generating an output, multiplied audio stem 425. For instance, given a 3-minute input stem 415, the multiplier engine 420 may randomly select the 1-minute portion from 0:27-1:27 for use in generating the multiplied audio stem output 425 (e.g., the multiplied stem 425 either may have a shorter length than the input stem 415, or the randomly chosen 1-min portion can be looped three times such that input stem 415 and output multiplied stem 425 have the same 3-min duration).

As a random selection of a portion of the input audio stem 415, the chosen portion of the stem may be unlikely to correspond to the most desirable sequence of audio data within the stem (e.g., the random 1-min selection may miss the hook or best riff within the input stem 415: may clip the hook or best riff at its beginning, ending, or both within the input stem 415: etc.). Over time, user feedback and input 442 can be collected and analyzed for the multiplied stem outputs 425 that are randomly generated by the multiplier engine 420, and can be used to train an ML model of the incremental learning engine 450) (or to fine-tune a pre-trained ML model of the incremental learning engine 450, etc.). For instance, the training or fine-tuning data inputs to the incremental learning engine 450) can comprise features or embeddings information of an input audio stem 415, the corresponding multiplied audio stem 425 generated as output by the multiplier engine 420, or both, and with labeling or annotation information for the audio stem features provided as (or based on) the corresponding user feedback information collected by user feedback and input engine 442 for the particular multiplied audio stem 425 output.

Over time, and with sufficient quantities of the user feedback and user input information 442 collected for previous multiplied stems 425 output by the multiplier engine 420), the incremental learning engine 450) can be trained or fine-tuned to accurately (or more accurately) predict the audio processing effects (e.g., audio FX engine 434-1, . . . , 434-n, ML tone-shaping 432, etc.) and one or more processing parameter values thereof, that are likely to receive a positive feedback rating from the user. In this manner, the incremental learning engine 450 can receive snapshot information corresponding to the user feedback inputs 442 for the multiplied stems 425 output in each cycle/round/iteration of the audio stem multiplication performed by the multiplier engine 420 (e.g., with a positive/negative rating for each multiplied stem, and/or with more specific user feedback or adjustments for some (or all) of the multiplied stems, etc.). Based on the user feedback 442 snapshot information for the most recent stem multiplication round, the incremental learning engine 450) can generate as output a predicted iterative configuration information that is provided to the audio stem multiplier engine 420 and used to configure or otherwise parameterize the next audio stem multiplication round that is to be performed for the input stems 415.

In some embodiments, incremental learning using to train or fine-tune the incremental learning engine 450 can be performed offline, for example using a training data set collected over a plurality of different users of the audio stem multiplier engine 420. In this manner, the incremental learning engine 450) learns the sound stem multiplication preferences and optimal adjustments over an average or representative body of users that correspond to the offline training data set (e.g., on average, the users seen during training or finetuning tend to provide positive feedback to multiplied audio stems 425 with characteristics/processing adjustments x, y, z, etc.). During deployment of the trained or fine-tuned incremental learning engine 450 (e.g., when performing inference using the trained/fine-tuned incremental learning engine 450, in support of audio stem multiplication cycles performed by the multiplier engine 420), the iterative configuration information output from the incremental learning engine to the multiplier engine 420) can be a configuration of audio stem adjustments or processing operations that are predicted to be the most likely to receive positive feedback from the average user, rather than the particular user of the audio stem multiplier engine 420 at the current moment. In another illustrative example, an initial offline training or fine-tuning process can be performed as described above, such that the incremental learning engine 450 learns the average preferences of audio stem multiplication for a set of users seen in the training data samples. Subsequently; the incremental learning engine 450) can collect user-specific or entity-specific (e.g., a company or studio that the user is employed by or works for, etc.) feedback information 442 for multiple rounds of multiplied stems 425 that receive the user feedback and inputs 442 after being output by the multiplier engine 420. When the user-specific or entity-specific multiplied stem feedback information 442 is sufficiently large enough of a dataset, the incremental learning engine 450) (e.g., already having been trained offline over the representative sample of userbase preferences) can be fine-tuned, re-trained, or otherwise adapted based on the user-specific or entity-specific multiplied stem feedback information 442 described above, to better predict iterative configuration information that more closely corresponds to the particular preferences expressed by that user or entity in rating the multiplied audio stem outputs 425 as either positive or negative.

In some embodiments, the multiplied stems 425 that are output from the multiplier engine 420 to the soundscape generation engine 470 can be the multiplied stems that receive a positive user feedback rating at the user feedback and user input block 442. In some examples, the multiplied stems 425 provided as the final output from multiplier engine 420 may be only the positive rating multiplied stems 425 generated (and user rated) in the final round of the multi-round, iterative stem multiplication process performed by the multiplier engine 420 and described above. In some aspects, the final output of multiplied stems 425 that is selected for use by the user can additionally be provided to a stem tagging engine 480), that can be used to automatically, manually, or using a combination of the two, provide one or more corresponding tags to each respective audio stem included in the final output set of multiplied audio stems 425. The tags can correspond to identifying or notable characteristics of each multiplied audio stem 425, which can include, but are not limited to, tagging information such as intensity type or level (high intensity, low intensity, moderate intensity; high-moderate varying intensity, high-low varying intensity, etc.); primary instrument or sound type (e.g., pad, percussion, voice, beat, etc.); mood (sleep, relax, energize, focus, study, work, etc.); BPM; and so on, etc. It is also noted that the stem tagging engine 480 can apply multiple different tags to a respective final output multiplied audio stem 425, such as “high-intensity percussion energize focus”, etc.

FIG. 5A is a diagram illustrating a first example of audio stem multiplication 500, in accordance with some examples. FIG. 5B is a diagram illustrating a second example of audio stem multiplication 550, in accordance with some examples. As illustrated, the first audio stem multiplication example 500 can correspond to an input set of audio stems 515a that are used to generate an output set of multiplied audio stems 525a using an asset multiplier 520. The asset multiplier 520 can be the same as or similar to the audio stem multiplier engine 420 of FIG. 4 (e.g., the terms asset multiplier and audio stem multiplier/multiplier engine may be used interchangeably herein). The same asset multiplier 520 is represented in FIG. 5A as in FIG. 5B. The second audio stem multiplication example 550 of FIG. 5B can correspond to an input set of audio stems 515a that are used to generate an output set of multiplied audio stems 525b-1, 525b-2, 525b-3.

In some aspects, the input audio stems 515a and 515b of FIGS. 5A and 5B (respectively) can be the same as or similar to the selected set of input audio stems 415 described above with respect to FIG. 4. Similarly, one or more (or all) of the output, multiplied audio stems 525a of FIG. 5A and/or 525b-1, 525b-2, 525b-3 of FIG. 5B can be the same as or similar to the output, multiplied set of audio stems 425 also described above with respect to FIG. 4.

In the example of FIG. 5A, the selected set of input audio stems 515a includes a ‘Vocals’ audio stem with a positive user feedback, a ‘Bass’ audio stem with positive user feedback, a ‘Beat’ audio stem with negative user feedback, a ‘Violin’ audio stem with positive user feedback, a ‘Piano’ audio stem with negative user feedback, a first ‘Stem’ audio stem with positive user feedback, a second ‘Stem’ audio stem with negative user feedback, and a third ‘Stem’ audio stem with positive user feedback. In some aspects, the respective positive or negative feedback associated with each respective one of the input audio stems 515a can be obtained using the user feedback and input engine 442 of FIG. 4, and/or can be included in or otherwise indicated by iterative configuration information from the incremental learning engine 450 of FIG. 4.

Based on the selected set of input audio stems 515a and the corresponding positive/negative user feedback information for each of the input audio stems 515a, the asset multiplier 520 can perform a subsequent or additional round/cycle/iteration of asset multiplication for the input audio stems 515a. In the example of FIG. 5A, the asset multiplier 520 can be configured to perform one-to-one audio stem or audio asset multiplication, where the number of input stems 515a is equal to the number of output stems 525a. In particular, the example of FIG. 5A shows assert multiplier 520 generating one variation/multiplied output stem 525a for each respective one of the input stems 515a. Also shown in the set of output stems 525a is the corresponding user feedback information indicating positive or negative rating of each multiplied stem 525a generated as output by the asset multiplier 520. In some aspects, the multiplied output stems 525a and corresponding user feedback rating information can be used as the input set of stems 515a and user feedback ratings for the next cycle of audio stem generation performed by the asset multiplier 520.

FIG. 5B can be the same as FIG. 5A, corresponding instead to a one-to-many asset (audio stem) multiplication example 550, rather than the one-to-one asset (audio stem) multiplication example 500 of FIG. 5A.

For instance, the asset multiplier 520 in the one-to-many configuration can generate as output a quantity of multiplied audio stems 525b-1, 525b-2, 525b-3 that is greater than the input quantity of audio stems 515b. As shown in FIG. 5B, three different multiplied audio stem variations can be generated for each input audio stem 515b. For instance, in some embodiments, the set of output stems 525b-1 can be a first variation stem generated for each of the input stems 515a (regardless of whether the input stem had a positive or negative feedback rating from the user), the set of output stems 525b-2 can be a second variation stem generated for each of the input stems 515a, and the set of output stems 525b-3 can be a third variation stem generated for each of the input stems 515a.

In another example, the one-to-many example of FIG. 5B can correspond to using the asset multiplier 520 to generate multiple variation audio stems (e.g., multiplied stems) for only the input audio stems 515a that have a positive user feedback rating in the selected set of input stems 515a (i.e., here, the Vocals input stem 515b corresponds to the vocals multiplied stem variation set 525b-1: the Beat input stem 515b corresponds to the beat multiplied stem variation set 525b-2: the Stem 1 input stem 515b corresponds to the Stem 1 multiplied stem variation set 525b-3: etc.).

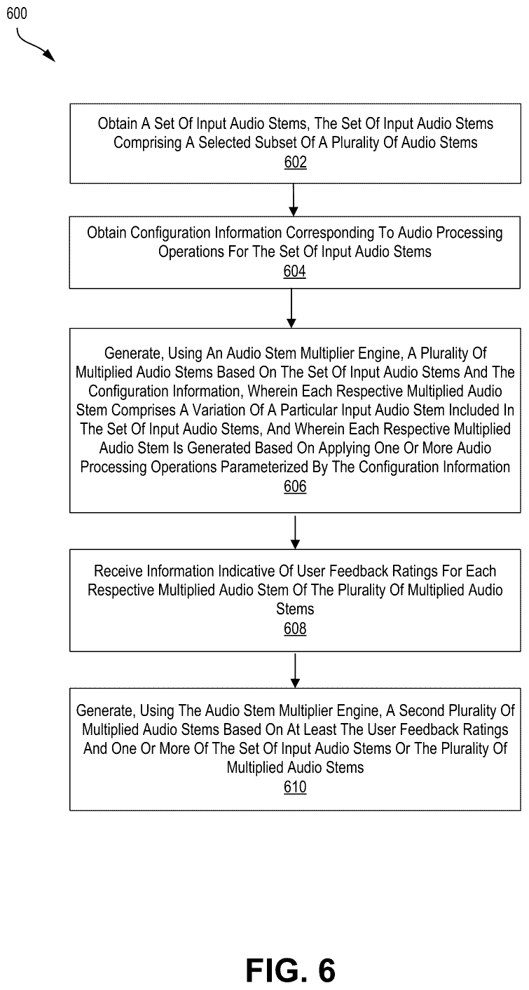

FIG. 6 is a block diagram illustrating a process 600 for processing one or more audio samples (e.g., audio stems, etc.). Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence. In some examples, the process 600 can be performed by various computing devices and/or components included within and/or associated with the audio processing system 100 of FIG. 1, etc.

At block 602, the process 600 includes obtaining a set of input audio stems, the set of input audio stems comprising a selected subset of a plurality of audio stems. For instance, the set of input audio stems can be the same as or similar to the input audio stems 415 of FIG. 4, the input audio stems 515a of FIG. 5A, and/or the input audio stems 515b of FIG. 5B, etc. In some cases, the set of input audio stems can be obtained from the audio stem compilation engine 410 of FIG. 4, and include a selected set of one or more pre-existing audio stems 402, one or more newly generated audio stems 404, or a combination of the two.

At block 604, the process 600 includes obtaining configuration information corresponding to audio processing operations for the set of input audio stems. For instance, the configuration information can be obtained from and/or based on the user feedback and input engine 442 of FIG. 4. In some cases, the configuration information can be the same as or similar to the iterative configuration information generated by the incremental learning engine 450 of FIG. 4 and provided to the audio stem multiplier engine 420 of FIG. 4. In some aspects, the audio processing operations for the set of input audio stems can correspond to one or more (or all) of the tone-shaping machine learning model 432, the audio processing effects engine 434-1, . . . , and/or the audio processing effects engine 434-n of FIG. 4.

In some examples, the configuration information for the set of input audio stems is indicative of a selected one or more audio processing operations or audio effects processing modules to be applied by the audio stem multiplier engine to generate the plurality of multiplied audio stems from the set of input audio stems. In some cases, the selected one or more audio processing operations or audio effects processing modules are selected based on one or more user inputs or based on user feedback ratings associated with a previous processing round performed by the audio stem multiplier engine. For instance, the previous processing round can be performed by the audio stem multiplier engine 420 of FIG. 4, which may be the same as or similar to the asset multiplier 520 of FIG. 5A and/or FIG. 5B.

At block 606, the process 600 includes generating, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information.

For instance, the audio stem multiplier engine can be the same as or similar to the audio stem multiplier engine 420 of FIG. 4, which may be the same as or similar to the asset multiplier 520 of FIG. 5A and/or FIG. 5B. In one illustrative example, the plurality of multiplied audio stems can be the same as or similar to the plurality of multiplied audio stems 425 of FIG. 4, the plurality of multiplied audio stems 525a of FIG. 5A, the plurality of multiplied audio stems 525b-1 of FIG. 5B, the plurality of multiplied audio stems 525b-2 of FIG. 5B, and/or the plurality of multiplied audio stems 525b-3 of FIG. 5B, etc.

In some cases, each respective multiplied audio stem is generated based on applying the one or more audio processing operations associated with one or more of the tone-shaping ML model 432, audio effects processing engine 434-1 . . . , and/or audio effects processing engine 434-n of FIG. 4, parameterized by user feedback and user inputs information 442 and/or parameterized by the iterative configuration information from incremental learning engine 450 of FIG. 4.

In some embodiments, a quantity of audio stems included in the plurality of multiplied audio stems is greater than a quantity of audio stems included in the set of input audio stems.

In some aspects, applying the one or more audio processing operations to generate a respective multiplied audio stem includes receiving configuration information indicative of a desired tone-shaping adjustment and processing, using a machine learning tone-shaping model, at least one input audio stem of the set of input audio stems to generate a corresponding one or more tone-shaped audio stems as output, wherein the machine learning tone-shaping model process the at least one audio stem based on the desired tone-shaping adjustment. For instance, the machine learning tone-shaping model can be the same as or similar to the tone-shaping ML model 432 of FIG. 4. IN some cases, applying the one or more audio processing operations further includes outputting the corresponding one or more tone-shaped audio stems within the plurality of multiplied audio stems.

At block 608, the process 600 includes receiving information indicative of user feedback ratings for each respective multiplied audio stem of the plurality of multiplied audio stems. For instance, the user feedback ratings can be received using the user feedback and inputs engine 442 of FIG. 4. In some aspects, the user feedback ratings can be the same as or similar to the positive user feedback ratings (e.g., check mark) and/or the negative user feedback ratings (e.g., ‘X’) associated with and shown for the various input audio stems 515a and 515b of FIGS. 5A and 5B and/or associated with and shown for the various output, multiplied audio stems 525a, 525b-1, 525b-2, 525b-3 of FIGS. 5A and 5B.

In some cases, the process 600 further includes outputting the plurality of multiplied audio stems for playback to a user and receiving the information indicative of the user feedback ratings based on outputting the plurality of multiplied audio stems for play back. For instance, the user feedback and input engine 442 can be used to both output the plurality of multiplied audio stems for playback to the user and to receive the information indicative of the user feedback ratings thereof. In some cases, the user feedback ratings comprise a positive user feedback rating or a negative user feedback rating for each respective audio stem variation included in the plurality of multiplied audio stems, for instance as shown in the examples of FIG. 5A and/or FIG. 5B.

At block 610, the process 600 includes generating, using the audio stem multiplier engine, a second plurality of multiplied audio stems based on at least the user feedback ratings and one or more of the set of input audio stems or the plurality of multiplied audio stems. In some aspects, the set of input audio stems includes one or more multiplied audio stems generated as output in a previous processing round performed by the audio stem multiplier engine. In some examples, the configuration information for the set of input audio stems includes the user feedback ratings information for each of the one or more multiplied audio stems generated as output in the previous processing round.

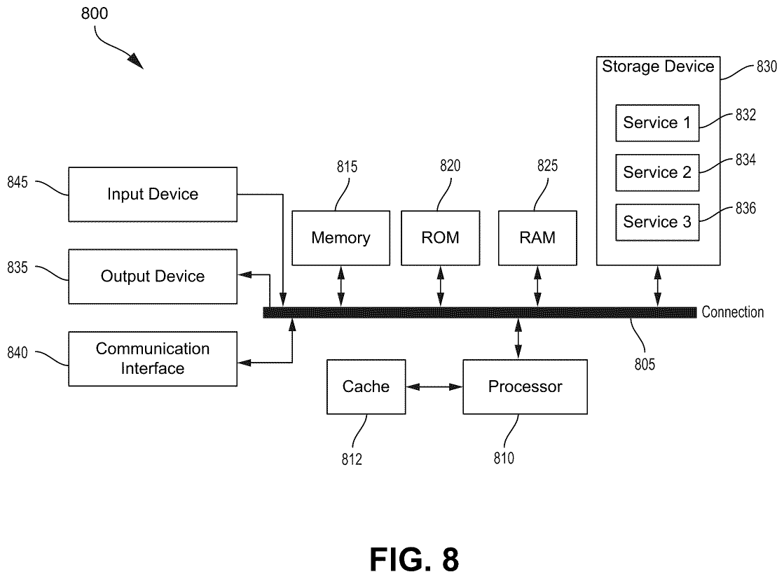

In some cases, the processes described herein (e.g., the process 600 and/or any other process described herein) may be performed by a computing device or apparatus. In one example, the process 600 and/or other technique or process described herein can be performed by the computing system 800 shown in FIG. 8. For instance, a computing device with the computing device architecture of the computing system 800 shown in FIG. 8 can implement the operations of the process 800, and/or can implement one or more of the components and/or operations described herein with respect to any of FIGS. 1 through 6.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 600 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 600 and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some embodiments, the process 600 and/or other process or technique described herein can be performed by or using one or more machine learning networks. For instance, the audio stem multiplier engine 420 of FIG. 4 can include one or more machine learning networks configured to implement the incremental learning engine 450, also shown in FIG. 4. In some aspects, the audio stem multiplier engine 420 of FIG. 4 can include one or more machine learning networks configured to perform FX chain suggestion for generating the multiplied audio stems 425 and/or for performing subsequent iterations of adjusting and generating additional variations or rounds of the multiplied audio stems 425. In some examples, the audio stem multiplier engine 420 can utilize and/or be associated with one or more machine learning networks configured to perform tone-shaping for generating one or more of the multiplied audio stems 425 based on one or more of the input selection of audio stems 415. For instance, the one or more tone-shaping machine learning networks can be the same as or similar to the tone-shaping ML model 432 of FIG. 4, etc.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as speech analysis, audio signal analysis, image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

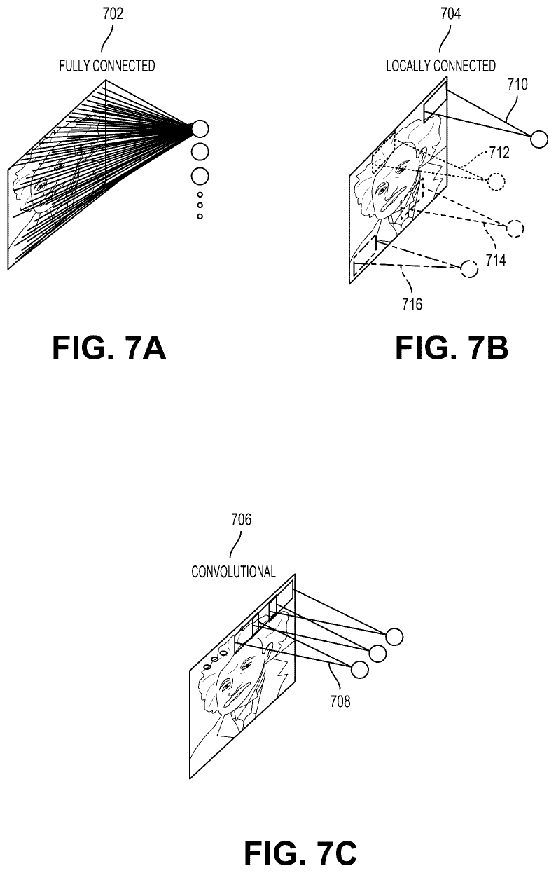

FIGS. 7A-7C illustrate example neural networks which may be used for keyword detection, in accordance with aspects of the present disclosure. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some cases, the connections between layers of a neural network may be fully connected or locally connected. FIG. 7A illustrates an example of a fully connected neural network 702. In a fully connected neural network 702, a neuron in a first layer may communicate its output to every neuron in a second layer, so that each neuron in the second layer will receive input from every neuron in the first layer. FIG. 7B illustrates an example of a locally connected neural network 704. In a locally connected neural network 704, a neuron in a first layer may be connected to a limited number of neurons in the second layer. More generally, a locally connected layer of the locally connected neural network 704 may be configured so that each neuron in a layer will have the same or a similar connectivity pattern, but with connections strengths that may have different values (e.g., 710, 712, 714, and 716). The locally connected connectivity pattern may give rise to spatially distinct receptive fields in a higher layer, as the higher layer neurons in a given region may receive inputs that are tuned through training to the properties of a restricted portion of the total input to the network.

One example of a locally connected neural network is a convolutional neural network. FIG. 7C illustrates an example of a convolutional neural network 706. The convolutional neural network 706 may be configured such that the connection strengths associated with the inputs for each neuron in the second layer are shared (e.g., 708). Convolutional neural networks may be well suited to problems in which the spatial location of inputs is meaningful.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 815 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory; magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z: or that multiple processors are each tasked with a certain subset of operations X, Y, and Z such that together the multiple processors perform X, Y, and Z: or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A method for audio processing, the method comprising:
obtaining a set of input audio stems, the set of input audio stems comprising a selected subset of a plurality of audio stems;
obtaining configuration information corresponding to audio processing operations for the set of input audio stems;
generating, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information;
receiving information indicative of user feedback ratings for each respective multiplied audio stem of the plurality of multiplied audio stems; and
generating, using the audio stem multiplier engine, a second plurality of multiplied audio stems based on at least the user feedback ratings and one or more of the set of input audio stems or the plurality of multiplied audio stems.

2. The method of claim 1, wherein a quantity of audio stems included in the plurality of multiplied audio stems is greater than a quantity of audio stems included in the set of input audio stems.

3. The method of claim 1, further comprising:
outputting the plurality of multiplied audio stems for play back to a user; and
receiving the information indicative of the user feedback ratings based on outputting the plurality of multiplied audio stems for playback.

4. The method of claim 3, wherein:
the user feedback ratings comprise a positive user feedback rating or a negative user feedback rating for each respective audio stem variation included in the plurality of multiplied audio stems.

5. The method of claim 1, wherein applying the one or more audio processing operations to generate a respective multiplied audio stem includes:
receiving configuration information indicative of a desired tone-shaping adjustment;
processing, using a machine learning tone-shaping model, at least one input audio stem of the set of input audio stems to generate a corresponding one or more tone-shaped audio stems as output, wherein the machine learning tone-shaping model process the at least one audio stem based on the desired tone-shaping adjustment; and
outputting the corresponding one or more tone-shaped audio stems within the plurality of multiplied audio stems.

6. The method of claim 1, wherein:
the set of input audio stems includes one or more multiplied audio stems generated as output in a previous processing round performed by the audio stem multiplier engine.

7. The method of claim 6, wherein:
the configuration information for the set of input audio stems includes the user feedback ratings information for each of the one or more multiplied audio stems generated as output in the previous processing round.

8. The method of claim 1, wherein the configuration information for the set of input audio stems is indicative of a selected one or more audio processing operations or audio effects processing modules to be applied by the audio stem multiplier engine to generate the plurality of multiplied audio stems from the set of input audio stems.

9. The method of claim 8, wherein the selected one or more audio processing operations or audio effects processing modules are selected based on one or more user inputs or based on user feedback ratings associated with a previous processing round performed by the audio stem multiplier engine.

10. A system for audio processing, the system comprising:
at least one processor; and
at least one memory storing instructions, which when executed cause the at least one processor to perform actions comprising:
obtaining a set of input audio stems, the set of input audio stems comprising a selected subset of a plurality of audio stems;
obtaining configuration information corresponding to audio processing operations for the set of input audio stems;
generating, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information;
receiving information indicative of user feedback ratings for each respective multiplied audio stem of the plurality of multiplied audio stems; and
generating, using the audio stem multiplier engine, a second plurality of multiplied audio stems based on at least the user feedback ratings and one or more of the set of input audio stems or the plurality of multiplied audio stems.

11. The method of claim 10, wherein a quantity of audio stems included in the plurality of multiplied audio stems is greater than a quantity of audio stems included in the set of input audio stems.

12. The method of claim 10, further comprising:
outputting the plurality of multiplied audio stems for play back to a user; and
receiving the information indicative of the user feedback ratings based on outputting the plurality of multiplied audio stems for playback.

13. The method of claim 12, wherein:
the user feedback ratings comprise a positive user feedback rating or a negative user feedback rating for each respective audio stem variation included in the plurality of multiplied audio stems.

14. The method of claim 10, wherein applying the one or more audio processing operations to generate a respective multiplied audio stem includes:
receiving configuration information indicative of a desired tone-shaping adjustment;
processing, using a machine learning tone-shaping model, at least one input audio stem of the set of input audio stems to generate a corresponding one or more tone-shaped audio stems as output, wherein the machine learning tone-shaping model process the at least one audio stem based on the desired tone-shaping adjustment; and
outputting the corresponding one or more tone-shaped audio stems within the plurality of multiplied audio stems.

15. The method of claim 10, wherein:
the set of input audio stems includes one or more multiplied audio stems generated as output in a previous processing round performed by the audio stem multiplier engine.

16. The method of claim 15, wherein:
the configuration information for the set of input audio stems includes the user feedback ratings information for each of the one or more multiplied audio stems generated as output in the previous processing round.

17. The method of claim 10, wherein the configuration information for the set of input audio stems is indicative of a selected one or more audio processing operations or audio effects processing modules to be applied by the audio stem multiplier engine to generate the plurality of multiplied audio stems from the set of input audio stems.

18. The method of claim 17, wherein the selected one or more audio processing operations or audio effects processing modules are selected based on one or more user inputs or based on user feedback ratings associated with a previous processing round performed by the audio stem multiplier engine.

19. At least one non-transitory computer readable medium storing instructions, which when executed causes at least one processor to:
obtain a set of input audio stems, the set of input audio stems comprising a selected subset of a plurality of audio stems;
obtain configuration information corresponding to audio processing operations for the set of input audio stems;
generate, using an audio stem multiplier engine, a plurality of multiplied audio stems based on the set of input audio stems and the configuration information, wherein each respective multiplied audio stem comprises a variation of a particular input audio stem included in the set of input audio stems, and wherein each respective multiplied audio stem is generated based on applying one or more audio processing operations parameterized by the configuration information;
receive information indicative of user feedback ratings for each respective multiplied audio stem of the plurality of multiplied audio stems; and
generate, using the audio stem multiplier engine, a second plurality of multiplied audio stems based on at least the user feedback ratings and one or more of the set of input audio stems or the plurality of multiplied audio stems.

20. The at least one non-transitory computer readable medium of claim 19, wherein the instructions cause the at least one processor to:
output the plurality of multiplied audio stems for playback to a user; and
receive the information indicative of the user feedback ratings based on outputting the plurality of multiplied audio stems for playback.
